(19) United States
(12) Patent Application Publication
(10) Pub. No.: US 2026/0117863 A1
(43) Pub. Date: Apr. 30, 2026

(54) VEHICLE AND METHOD FOR DISENGAGING A PARKING LOCK IN SUCH A VEHICLE

(71) Applicant: AUDI AG, Ingolstadt (DE)

(72) Inventors: Lukas HEIL, Adelschlag (DE); Markus GMELCH, Wolnzach (DE); Andreas NIEDERMAIER, Ingolstadt (DE); Manuel PAßLER, Weißenburg (DE)

(73) Assignee: AUDI AG, Ingolstadt (DE)

(21) Appl. No.: 19/359,510

(22) Filed: Oct. 15, 2025

(30) Foreign Application Priority Data
Oct. 21, 2024 (DE) 10 2024 130 482.0

(51) Int. Cl. F16H 63/34

(52) U.S. Cl. CPC F16H 63/3458

(57) ABSTRACT

The invention relates to a vehicle having an electric machine (EM) with an output which drives the vehicle wheels (2) via a drive train, wherein a parking lock (4) with a pawl (5) and a locking gear (7) is installed in the drive train, wherein in a determined parking situation the engaged pawl (5) is subjected to a load, and wherein for load-free parking lock disengagement a central control unit (11) actuates the pulse-controlled inverter (PWR) of the electric machine (EM) in order to rotate the rotor shaft (1) thereof in a direction of rotation (D) by a target angle of rotation (α_{target}), namely by generating a relief torque (M) with which the load acting on the parking lock (4) can be relieved. According to the invention, the pulse-controlled inverter (PWR) is integrated together with a rotor position sensor (15) in a control circuit (R). By means of the control circuit (R), a rotation angle control mode can be carried out in which the electric machine (EM) is controlled with the relief torque (M).

### TECHNICAL FIELD

The present disclosure relates to a vehicle with a parking lock and to a method for disengaging the parking lock.

### BACKGROUND

A battery-powered vehicle has an electric machine that transmits power to the vehicle wheels via a drive train. The drive train contains a parking lock with a pawl and a cooperating locking gear. When the parking lock is engaged, the pawl is positively engaged with the locking gear, preventing the vehicle wheel from turning. The torque applied by the locked vehicle wheel to the parking lock is transferred via the positive connection of the locking gear with the pawl to a drive module housing and further via the assembly mount to the vehicle body or the subframe. In determined parking situations, such as when a vehicle is parked on an incline, the parking lock is placed under load. In order to pull the pawl out of the locking gear, a correspondingly more powerful and therefore more expensive parking lock actuator is required that can overcome the frictional force between the pawl and the locking gear.

Alternatively, in a vehicle of this type, the locking gear is rotated relative to the pawl in such a way that it is possible to disengage the pawl with almost no force. This leads to a convenience advantage, as there is no vibration in the drive train when the pawl is disengaged.

From DE 10 2017 121 007 A1, a method for actuating a parking lock of a motor vehicle is known, the motor vehicle having a pawl and a locking gear cooperating therewith. In the event of a load between the pawl and the locking gear caused by the inclination of the road, a control apparatus initiates a targeted rotation of the locking gear in order to release the load during a parking lock disengagement process.

DE 10 2017 123 076 A1 describes a parking lock. In order to allow the parking lock to be disengaged under low load, a detection device for detecting the position of a locking element of the parking lock and a control device for rotating a parking lock gear depending on the position of the locking element are provided.

From DE 10 2014 207 997 A1, a method for disengaging a parking lock is known, in which a relief torque is applied to the parking lock to disengage the parking lock. The relief torque is applied to the parking lock by a corresponding actuation.

In the prior art, only a general rotation of the locking gear is disclosed in order to release the load on the parking lock, with a view to load-free parking lock disengagement. Therefore, the prior art lacks a concrete technical implementation of how a precise rotation of the locking gear should be carried out in order to relieve the load on the engaged parking lock so that the parking lock can be disengaged smoothly.

### BRIEF DESCRIPTION OF THE DRAWINGS/FIGURES

FIG. 1 illustrates a block diagram of the structure and functionality of a parking management system, according to some embodiments.

### DETAILED DESCRIPTION

The object of embodiments herein is to provide an electrically operated vehicle having a parking lock, wherein a load in the parking lock can be relieved in a structurally simple and targeted manner in order to ensure a smooth parking lock disengagement process.

The object may be achieved by the features of the independent claims.

The present disclosure is based on a vehicle having an electric machine that transmits power to the vehicle wheels via a drive train. The drive train contains a parking lock with a pawl and a cooperating locking gear. In a determined parking situation, such as when the vehicle is parked on an incline, a load occurs in the engaged parking lock. To ensure a load-free disengagement process, a central control unit activates the pulse-controlled inverter of the electric machine to rotate its rotor shaft in a direction of rotation by a target angle of rotation. In this way, a relief torque is generated with which the load acting on the parking lock can be relieved. According to some embodiments, the following measures are taken to provide a precise relief function by means of which a load-free parking lock disengagement process can be carried out: The pulse-controlled inverter of the electric machine is integrated into a control circuit together with a rotor position sensor, a comparator module and a control module. In order to relieve the load on the parking lock, the control circuit carries out a rotation angle control mode in which the comparator module generates a torque control parameter from a comparison between the target angle of rotation and an actual angle of rotation of the rotor shaft detected by the rotor position sensor. Based on this torque control parameter, a control module of the pulse-controlled inverter actuates the electric machine with the relief torque. The provision of the control circuit allows for precise process control with a correspondingly high control quality in order to make the parking lock disengagement process load-free.

In some embodiments, the control module can be used to ramp up the relief torque in a control range from 0 to a maximum value. The following control process is therefore carried out in the control circuit: If there is a difference in the angle of rotation between the target angle of rotation and the actual angle of rotation, the control module ramps up the relief torque towards the maximum value, namely until the actual angle of rotation in the comparator module matches the target angle of rotation. Alternatively, the control module increases the relief torque until the relief torque reaches the maximum value.

As soon as the actual angle of rotation detected by the rotor position sensor in the comparator module matches the target angle of rotation, the pulse-controlled inverter generates a zero-torque signal. If such a zero-torque signal is present, the central control unit activates a parking lock actuator to start the parking lock disengagement process without load.

The above process sequence is carried out in a rotation angle control mode that works in the absence of malfunction. In contrast to this, aspects disclosed herein are described below which are relevant in the case of a malfunction in the rotation angle control mode: In an initial control process taking place in the malfunctioning rotation angle control mode, the control module can ramp up the relief torque to the maximum value, namely without a match between the target angle of rotation and the actual angle of rotation being achieved. In this process situation, the pulse-controlled inverter determines there is an error. Such an error occurs, for example, if the rotor shaft is rotated in the incorrect direction of rotation or the rotor position sensor is defective.

If such an error occurs, the following process chain can be carried out in the vehicle, according to which:
the pulse-controlled inverter generates the zero-torque signal as soon as the relief torque has been ramped up to the maximum value by means of the control module; and
if the zero-torque signal is present, the control device actuates the parking lock actuator to start the parking lock disengagement process.

This disengagement process may not be successful. If the disengagement process is unsuccessful, a second control process with the opposite direction of rotation is carried out in the further course of the process. If the target angle of rotation and the actual angle of rotation do not match in the second control process, the pulse-controlled inverter generates a warning message for the driver.

The following describes a signal processing in the vehicle's parking management system that can be carried out if an unsuccessful disengagement process occurs after the initial control process: If an unsuccessful disengagement process occurs after the initial control process, the parking lock actuator can generate an error signal. The second control process starts as a result.

In some embodiments, the error signal from the parking lock actuator can first be sent to the central control unit, which then actuates the pulse-controlled inverter accordingly to start the second control process. Alternatively, other embodiments may be provided with a view to a simplified signal processing: The parking lock actuator can be in direct signal connection with the pulse-controlled inverter, i.e., without the central control unit being interposed. In this case, the error signal generated by the parking lock actuator is sent directly to the pulse-controlled inverter, bypassing the central control unit.

In some embodiments, the load of the engaged parking lock is detected by the central control unit as follows: The central control unit can be in signal connection with a vehicle position sensor. This detects a vehicle position angle. Based on the detected vehicle position angle, the central control unit can determine whether or not the engaged parking lock is under load. In addition, the central control unit determines the target direction of rotation based on the detected vehicle position angle.

In addition, the target angle of rotation can be stored as a fixed parameter in the pulse-controlled inverter or in the central control unit.

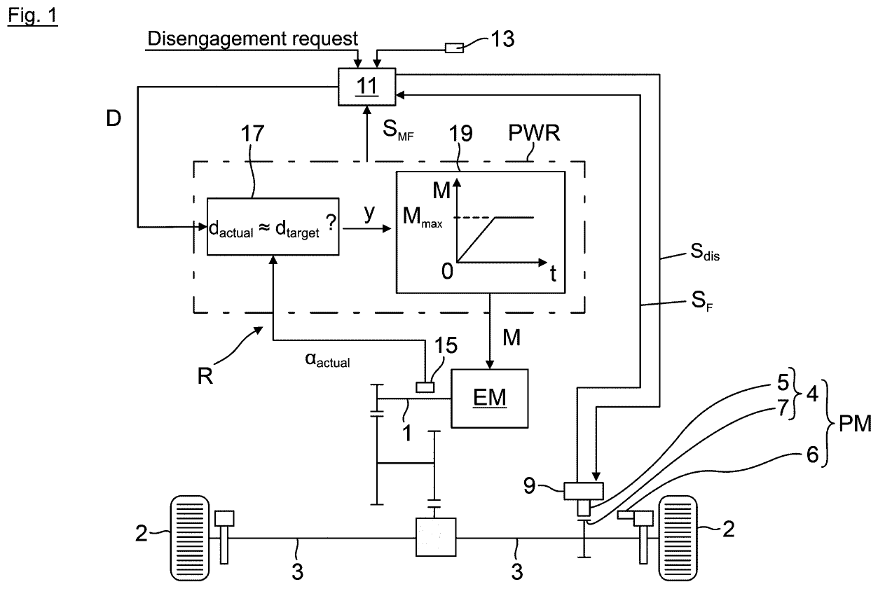

An embodiment is described below with reference to FIG. 1, which shows a schematic block diagram illustrating the structure and functionality of a parking management system according to some embodiments.

The drawing shows a rough schematic of an electrified vehicle axle of a two-track vehicle. The vehicle axle has an electric machine EM which drives the two vehicle wheels of the vehicle axle via a drive train. For this purpose, the electric machine EM with its rotor shaft 1 is connected via a transmission to an axle differential in a manner creating a drive; from there, each of the two output ends thereof leads to an output shaft 3 and to the corresponding vehicle wheel 2. Each of the two vehicle wheels 2 is assigned a wheel brake.

In the drawing, a parking management system PM of the vehicle consists of a parking actuator 6 acting on the right wheel brake in the drawing and of a parking lock 4, which is constructed from a pawl 5 supported on the vehicle body and a locking gear 7 cooperating therewith, which is connected in a rotationally fixed manner to the output shaft 3.

The pawl 5 can be engaged or disengaged by means of a parking lock actuator 9. The parking lock actuator 9 can be controlled by a central control unit 11. The central control unit 11 controls the parking lock actuator 9 to engage or disengage the parking lock 4. In the drawing, the central control unit 11 has a signal connection with a vehicle position sensor 13 which detects a vehicle position angle of the parked vehicle. In addition, the central control unit 11 has a signal connection with a pulse-controlled inverter PWR of the electric machine EM.

In a parking situation, the parking lock 4 is engaged to prevent the parked vehicle from rolling away. As soon as the central control unit 1 detects a driver's disengagement request, the central control unit 11 first evaluates, based on the vehicle position angle detected by the vehicle position sensor 13, whether there is any load on the engaged parking lock 4, as is the case, for example, when the vehicle is parked on an incline. If the central control unit 11 detects such a load of the engaged parking lock 9, the central control unit 11 actuates the pulse-controlled inverter PWR of the electric machine EM with a target direction of rotation D, which has been determined in the central control unit 11 based on the vehicle position. In this way, the rotor shaft 1 is rotated in the direction of rotation D with a target angle of rotation α_{target}, which is stored as a fixed parameter in the pulse-controlled inverter PWR, for example. The rotor rotation occurs by generating a relief torque M, with which the load acting on the parking lock 4 is relieved.

A core idea of the embodiments herein consists in the technical implementation, described below, of a precise control of the rotor shaft 1 of the electric machine EM in order to ensure a smooth, i.e., torque-free, parking lock disengagement process: The pulse-controlled inverter PWR has a comparator module 17 and a control module 19, which are integrated into a control circuit R together with a rotor position sensor 15. By means of the control circuit R, a rotation angle control mode can be carried out in which the comparator module 17 generates a torque control parameter y from a comparison between the target angle of rotation α_{target} and an actual angle of rotation α_{actual} of the rotor shaft 1 detected by the rotor position sensor 15.

Based on the torque control parameter y generated by the comparator module 17, a downstream control module 19 of the pulse-controlled inverter PWR actuates the electric machine EM with the relief torque M. As indicated in the drawing, the control module 19 can ramp up the relief torque M in a control range from 0 to a maximum value Mₘₐₓ.

With the control circuit R, a control process can be carried out as follows: If there is a difference in the angle of rotation between the target angle of rotation α_{target} and the actual angle of rotation α_{actual}, the comparator module 17 generates a torque control parameter y which correlates with the magnitude of the rotation angle difference. The torque control parameter y can be used to control the control module 19, which actuates the electric machine EM with the relief torque M. The control module 19 ramps up the relief torque M towards the maximum value Mₘₐₓ until the actual angle of rotation α_{actual} in the comparator module 17 comes into agreement with the target angle of rotation α_{target}.

As soon as the actual angle of rotation α_{actual} detected by the rotor position sensor 15 is in agreement with the target angle of rotation α_{target} in the comparator module 17, the pulse-controlled inverter PWR generates a zero-torque signal S_{M}. If the zero-torque signal S_{M} is present, the central control unit 11 controls the parking lock actuator 9 to start the parking lock disengagement process.

The previous description describes a control process in an rotation angle control mode without a malfunction. In contrast to this, a malfunctioning rotation angle control mode is described below, which occurs, by way of example, when the central control unit 11 determines an incorrect target direction of rotation D, or when the rotor position sensor 15 is defective.

In such an error situation, in an initial control process in the rotation angle control mode, the control module 19 can ramp up the relief torque M up to the maximum value Mₘₐₓ, namely without an agreement being achieved between the target angle of rotation α_{target} and the actual angle of rotation α_{actual}. In this case, the parking management system PM can carry out the following process chain, according to which
the pulse-controlled inverter PWR generates the zero-torque signal S_{M} as soon as the relief torque M has been ramped up to the maximum value Mₘₐₓ by the control module 19; and
if the zero-torque signal S_{M} is present, the central control unit 11 actuates the parking lock actuator 4 to start the disengagement process.

If this disengagement process is not successful, the parking lock actuator 9 generates an error signal S_{F}, which is relayed to the central control unit 11. In response, the central control unit 11 activates the pulse-controlled inverter PWR to start a second control process with the reverse direction of rotation. If no agreement is reached between the target angle of rotation α_{target} and the actual angle of rotation α_{actual} in the second control process as well, the pulse-controlled inverter PWR generates a warning message for the driver.

In the above embodiment, in the event of an error in an initial control process in the rotation angle control mode, the control module 19 can ramp up the relief torque M up to the maximum value Mₘₐₓ, namely without an agreement being achieved between the target angle of rotation α_{target} and the actual angle of rotation α_{actual}. In this situation, the control module 19 can alternatively reverse the direction of rotation independently and attempt to achieve the desired target angle of rotation in the direction opposite to the target angle of rotation. This architectural alternative saves transmission time on the communication bus.

### LIST OF REFERENCE SIGNS

1 rotor shaft
2 vehicle wheel
3 output shaft
4 parking lock
5 pawl
6 parking actuator
7 locking gear
9 parking lock actuator
11 central control unit
13 vehicle position sensor
15 rotor position sensor
17 comparator module
19 control module
R control circuit
α_{target} target angle of rotation
α_{actual} actual angle of rotation
S_{F} error signal
PWR pulse-controlled inverter
S_{M} zero-torque signal
M relief torque
y torque control parameter
PM parking management

1-10. (canceled)

11. A system comprising:
a pawl;
a locking gear;
a parking lock;
a drive train coupled to the locking gear and the parking lock;
a motor vehicle; and
an electric machine (EM) coupled to the pawl, the drive train, and the motor vehicle, and configured to:
generate a relief torque with which a load can be relieved from the pawl, wherein the pawl is subjected to the load;
generate a target angle of rotation based on the relief torque;
actuate a pulse-controlled invertor (PWR) of the EM to rotate a rotor shaft in the direction of rotation to the target angle of rotation, wherein the PWR comprises a rotor position sensor;
determine, via the rotor position sensor, a difference between the target angle of rotation and an actual angle of rotation based on actuating the PWR, and
generate, by one or more processors, a torque control parameter based on determining the difference between the target angle of rotation and the actual angle of rotation.

12. The system according to claim 11, wherein the EM is further configured to:
increase the relief torque until the actual angle of rotation is in agreement with the target angle of rotation, or until the relief torque reaches a maximum value.

13. The system according to claim 11, wherein the EM is further configured to:
determine the actual angle of rotation is in agreement with the target angle of rotation;
in response to determining the actual angle of rotation equals the target angle of rotation, generate a zero-torque signal; and
actuating a parking lock actuator to disengage the parking lock based on generating the zero-torque signal.

14. The system according to claim 12, wherein the EM is further configured to:
determine an error based on the relief torque reaching the maximum value without the target angle of rotation and the actual angle of rotation being in agreement, the error being the rotor shaft rotating the incorrect direction of rotation or that the rotor position sensor is defective.

15. The system according to claim 14, wherein the EM is further configured to:
generate the zero-torque signal based on determining the error; and
disengage the parking lock using the parking lock actuator based on generating the zero-torque signal.

16. The system according to claim 15, wherein the EM is further configured to:
determine disengaging the parking lock was not successful;
rotate in an opposite direction of the direction of rotation to the target angle of rotation;
determine no agreement was reached between the target angle of rotation and the actual angle of rotation; and
generate a warning message to a driver based on determining no agreement was reached.

17. The system according to claim 14, wherein the EM is further configured to:
generate, via the parking lock actuator, an error signal; and
transmit the error signal to the PWR based on generating the error signal.

18. The system according to claim 11, wherein the EM is further configured to:
detect a vehicle position angle; and
determine there is a load on an engaged parking lock based on detecting the vehicle position angle.

19. The system according to claim 11, wherein the target angle of rotation is stored as a fixed parameter in the PWR.

20. A method for disengaging a parking lock in a motor vehicle comprising:
generating a relief torque with which a load can be relieved from a pawl, wherein the pawl is subjected to the load;
generating a target angle of rotation based on the relief torque;
actuating a pulse-controlled invertor (PWR) of an electric machine (EM) to rotate a rotor shaft in the direction
of rotation to the target angle of rotation, wherein the PWR comprises a rotor position sensor;
determining, via the rotor position sensor, a difference between the target angle of rotation and an actual angle of rotation based on actuating the PWR; and
generating, by one or more processors, a torque control parameter based on determining the difference between the target angle of rotation and the actual angle of rotation.
